(19) United States
(12) Patent Application Publication
(10) Pub. No.: US 2026/0100893 A1
(43) Pub. Date: Apr. 9, 2026

(54) METHOD FOR DYNAMIC INTENT MANAGER PROFILE EXPOSURE

(71) Applicant: Telefonaktiebolaget LM Ericsson (publ), Stockholm (SE)

(72) Inventors: Pedro Henrique GOMES DA SILVA, Indaiatuba (BR); Amadeu Do Nascimento JUNIOR, Indaiatuba (BR); Andrey José TORRES DA SILVA, Ananindeua (BR)

(21) Appl. No.: 19/114,981

(22) PCT Filed: Oct. 7, 2022
(86) PCT No.: PCT/SE2022/050908

§ 371 Date: Mar. 25, 2025

(51) Int. Cl. H04L 41/5041; H04L 41/5019

(52) U.S. Cl. CPC H04L 41/5041; H04L 41/5019

(57) ABSTRACT

According to one aspect, a method performed by an intent handler for managing intents in a communications network is provided. The method includes generating a first message, the first message comprising a request to register a basic intent handler profile, wherein the basic intent handler profile comprises a first set of information relating to one or more capabilities of the intent handler. The method includes transmitting the first message towards an intent manager registry. The method includes receiving a second message, the second message comprising an identifier of an intent owner. The method includes selecting, based on the identifier, advanced information to complement the basic intent manager profile, wherein the advanced information comprises a second set of information different than the first set of information. The method includes generating a third message, the third message comprising the second set of information. The method includes transmitting the third message towards the intent owner.

### TECHNICAL FIELD

Disclosed are embodiments related to intent-driven management, service management, and orchestration.

### INTRODUCTION

Network operations of the future require an increased autonomy of networks, which means that business, service, and resource operations are able to decide and take the right actions based on dynamic goals and requirements of new services. The decision-making processes in autonomous networks should take place ideally without any human intervention. In this scenario, the business objectives, as well as the expectations of customers and users, are communicated to the parts (e.g., management domains, systems) that constitute the autonomous network by means of intents.

Intent-driven management is a new paradigm in network and services management where the main objective is to move networks operations from manual or automated towards fully autonomous networks. Any autonomous system needs to take decisions; therefore, it is essential that the autonomous system knows its requirements, goals and constraints. The intents are the knowledge that enable the automation of intelligent decisions taken by the autonomous systems. Intents express “what” should be achieved and do not prescribe “how” it should be done; the final decisions are made by the autonomous system. The intents should be used by the receiving system (autonomous system) to understand what is expected to be achieved, including utility models, preferential outcomes, etc.

Intents are defined as “the formal specification of all expectations including requirements, goals, and constraints given to a technical system” [1]. This definition is commonly used throughout different standardization groups, e.g., TM Forum, 3^{rd} Generation Partnership Project (3GPP) Technical Specification Group Service and System Aspects Working Group 5 (SA5), and European Telecommunications Standards Institute (ETSI) Zero Touch Network and Service Management (ZSM). One important aspect of the intents definition is that it should be a formal specification, which means that intents should be expressed with formally defined and complete semantics and vocabulary. This is achieved with the definition of formal models that cover the required expressiveness.

There are different possibilities for modeling intents and how they are formally expressed. Since intents need to be used in multi-vendor and multi-domain environments, a common modeling and language is required for interoperability. TM Forum's Autonomous Networks project has worked on a set of guidelines and specifications that provide the details on the use of intent in autonomous networks and the formal intent modeling [1-6].

In any management system (that may be composed by sub-systems), intents are knowledge used for the communication of requirements, goals, and constraints between two entities, named intent managers, or intent management functions. As knowledge objects, the life cycle of intents can be managed, i.e., new intents can be created, existing intents may be changed, intents can be removed from (sub)systems, etc. Each intent manager will play a distinct role in the life cycle of the intents, either as an intent owner (the origin of the intent, who has the requirements, goals, and constraints) or as the intent handler (the receiver of the intent, who must fulfil the requirements, goals, and constraints).

When an intent owner creates an intent to specify a set of requirements, goals or constraints, it creates an intent object instance that should be uniquely identified in the management (sub)system. In practical scenarios with multiple layers of management and autonomous domains, multiple intent managers are needed, and they may play the roles of owner and/or handler for different intent object instances depending on the direction of the communication that is required. An intent object instance, however, is owned by one single intent owner, and it must be sent to one single intent handler for its fulfilment.

The intent manager registry is a logical entity that has the intent manager capability profiles of registered intent managers. It allows intent managers to discover each other and also query their supported management scopes, interface procedures and expressiveness (intent models supported and partially supported).

During the task of intent distribution, the intent owner must find the right intent handler for the specific intent object instance, and this is done using the intent manager registry capabilities, as shown in FIG. 1. FIG. 1 illustrates intent managers 102A-B, and an intent manager registry 104 with intent manager capability profiles 106. As described in [5], the intent manager registry function 104 stores information about all available intent managers 102A-B. Furthermore, it enables the discovery of intent managers through queries about the profiles 106. The interfaces of the intent manager registry are shown in FIG. 1. The intent manager registration interface allows uploading intent manager capability profiles to the intent manager registry. This publishes the presence of an intent manager and its scope and capabilities. The intent manager discovery interface allows searches in the published intent manager capability profiles.

Intent manager discovery is essential for intent owners deciding if they can use intent towards an autonomous domain and what they can express with this intent. The discovery answers the question if there is a respective intent manager present in the system with a scope that matches the target domain. On the other hand, intent handlers need discovery to get access to the capabilities of the intent owner.

An intent manager capability profile 200 can be expressed using the model defined in FIG. 2. As described in [5], intent management functions differ with respect to the domain they manage, but also regarding their capabilities. They might support a different set of intent extension models, serialization formats and intent interface procedures. This model defines vocabulary for expressing these aspects of an intent manager capability and thus allow to formulate an intent manager capability profile.

Intent manager address and contact information specifies how to contact the instance of the intent management function the profile is about. This is used for addressing of messages on the intent interface towards this instance. The string can for example contain the IRI that is representing the intent manager instance.

Intent Management Scope defines the intent management scope(s) this intent manager is responsible for. Usually there is one scope per intent manager, but it is allowed to define multiple scopes if the responsibility of this instance of the intent manager extents to all of them. The scope Identifier usually implies a domain specific implementation of the intent manager. Further differentiation of scopes is possible if the domain is further partition with multiple instances of intent management. This can for example be geographic partitioning if the network is divided into separately operated regions.

Intent LSM role. An intent manager has the capability to take the role of an intent owner, intent handler or both. An intent handler that only takes the owner role usually a top level source of intent. It would be associated with user portals or management functions that define requirements, but are themselves not intent aware.

Supported notation format. Intent and intent reports are knowledge graphs in the form of an ontology. For sending them over the intent interface these graphs need to be serialized. Multiple notation formats are available for this, for example TURTLE, RDF/XML or JSON-LD. The intent manager states its support for notation formats in its capability profile. It can further differentiate by supported version of the notation format.

Supported interface procedures. The intent interface defines four sets of procedures: (1) the SET/REMOVE/REPORT interface procedure. One version of this procedure is mandatory to support; (2) the JUDGE/PREFERENCE interface procedure; (3) the PROBE/ESTIMATE interface procedure; (4) the BEST/PROPOSAL interface procedure. The intent manager capability model specifies which of them is supported. Options are defined in the intent interface ontology. The model allows specifying which versions of the interface procedures are supported. In this respect it is sensible to also specify the mandatory SET/REMOVE/REPORT procedure and state which exact version are supported.

Supported Models defines the models that can be used in intent and intent reports and would be understood by the intent manager. This implicitly defines the model federation that is possible to use with the intent manger. It is possible to define models that are considered fully supported with the imp:supportedModels property and then define exceptions with the imp:notSupportedModelArtifact property. Alternatively it is possible to mention a model as partially supported with the imp:partiallySupportedModels property. This requires that all model artifacts that are supported must be explicitly mentioned with the imp:supportedModelArtifact property. It is further possible to state separately if a model and its artifacts are supported by the intent manger when it has the role of intent owner or intent handler. This means some models are only supported in intents that are received and other only in intents that the intent manager creates and sends to other intent managers for handling. Model artifacts that can be explicitly supported or not refers to the entire vocabulary specified by the model. Typical examples are classes, properties and individuals defined in the model.

### SUMMARY

Intent managers can receive intents from different sources. For instance, an intent manager that is developed by one network operator (or vendor) can receive and send intents to other intent managers either developed by the same network operator (or vendor) or by competitors. Intent managers from different operators may also exchange intents. Furthermore, intents may also come from other vertical industries towards network operators.

The intent models specified by IG1253 [1] are composed by a common set of classes and properties that form an intent common model, in addition to specific intent model extensions. The intent common model is detailed in TM Forum's TR290 [2], while the intent model extensions are detailed in TR291 [3]. The intent model extensions can be developed independently by other standardization organizations besides TM Forum, as well by other companies (e.g., vendors, operators, etc.) interested in developing models for specific management domains, e.g., radio access networks (RAN), transport, cloud, internet of things (IoT), etc.

The developer of intent managers may create intent model extensions that enable the support of intents that are very specialized, e.g., for optimal performance, cost, or to delivery proprietary features. For instance, a vendor that develops intent managers with the scope of transport management may develop intent extension models that allow the specification of fine-grained requirements and constraints, thus, exposing more expressiveness to the intent owner that creates an intent based on these specialized models.

For business reasons, some of the intent extension models should not be used to create intents that are originated from specific intent managers. For instance, a vendor may not want to expose detailed requirements to be expressed by intents coming from a competitor's intent manager; or one operator may want to hide internal requirement details when sending (or receiving) intents to (from) another operator; even further, depending on contractual conditions, operators may want to expose more capabilities for intent expression to specific vertical industries, or specific partners.

Furthermore, optional interface procedures may be provided by the intent managers and these capabilities could be used only for communication with specific types of intent managers, e.g., only intent managers within the same operator's domain, or only between same vendors due to any business or technical reason.

Current standardization of intent manager registry and how intent manager profiles are expressed does not support an informed decision on the exposure of an intent manager supported models, the interface optional procedures, etc. Ideally, different intent manager profiles should be used during the intent handler discovery phase, so that the right level of capabilities (models, interface methods, etc.) exposure can be achieved.

Aspects of the present disclosure include techniques that allow intent managers playing the role of intent handlers to hide information to a desired level of detail by means of selecting the best intent extension models and interface procedures to be used by intent object instances coming from other intent managers playing the role of intent owners. In simple terms, the intent handlers can restrict the types of intents that it will receive and process depending on the intent owner that it is talking to, and the type of operations that will be used on the intent-based interface.

In some aspects, the techniques disclosed herein may be based on the management functions and the intent models standardized by TM Forum standards, but can be extended to other standards as the concept of intent is incorporated into other management architectures, e.g., in the Open RAN Alliance's (O-RAN) service management and orchestration (SMO) platform, ETSI ZSM management architecture, or 3GPP SA5 management services.

When an intent handler wants to hide information while communicating with an intent owner, the intent handler can simply create an Intent Manager Profile that contains the intent extension models and interface procedures with the right level of expressiveness, i.e., that do not announce the support of detailed intent extension models and interface procedures that should not be used by the specific intent owner when creating the intent object instances.

The intent handler, however, needs to know what the intent owner's identification in advance is in order to expose the correct intent extension model. This can be achieved by an Intent Manager Registry that does not expose the intent models supported by the intent handler, which forces the intent owner to ask for such information. Alternatively, the Intent Manager Registry can act as a service exposure function and redirect the intent manager profile request to the intent handler, which will respond with the right list of supported intent extension models.

According to one aspect, a method performed by an intent handler for managing intents in a communications network is provided. The method includes generating a first message, the first message comprising a request to register a basic intent handler profile, wherein the basic intent handler profile comprises a first set of information relating to one or more capabilities of the intent handler. The method includes transmitting the first message towards an intent manager registry. The method includes receiving a second message, the second message comprising an identifier of an intent owner. The method includes selecting, based on the identifier, advanced information to complement the basic intent manager profile, wherein the advanced information comprises a second set of information different than the first set of information. The method includes generating a third message, the third message comprising the second set of information. The method includes transmitting the third message towards the intent owner.

In some embodiments, the second message is received from the intent owner.

In some embodiments, the second message is received from the intent manager registry. In some embodiments, the third message is transmitted towards the intent owner via the intent manager registry.

In some embodiments, the basic intent manager profile comprises: an intent manager address, an intent management scope, and an intent life cycle role. In some embodiments, the advanced information comprises one or more of: a notation format, an interface procedure, a supported model, or a partially supported model. In some embodiments, the identifier comprises one or more of a uniform resource identifier (URI) or an internet protocol (IP) address of the intent owner. In some embodiments, the basic intent handler profile comprises an intent common model and the advanced information comprises one or more extensions to the intent common model. In some embodiments, the advanced information enables support of one or more intents relating to at least one of: optimal performance, cost, or delivery of a proprietary feature in a communications network.

In some embodiments, the selecting further comprises determining, based on the identifier, that the intent owner belongs to a same network operator of a communications network as the intent handler, and wherein the advanced information comprises information relating to capabilities of the intent handler for a proprietary feature in the network.

In some embodiments, the selecting further comprises determining, based on the identifier, that the intent owner belongs to a different network operator of a communications network as the intent handler, and wherein the advanced information comprises information relating to capabilities of the intent handler for a non-proprietary feature in the network.

According to another aspect, a method performed by an intent manager registry in a communications network is provided. The method includes receiving, from an intent handler, a first message, the first message comprising a request by the intent handler to register a basic intent handler profile, wherein the basic intent handler profile comprises a first set of information relating to one or more capabilities of the intent handler. The method includes storing the basic intent handler profile in a database. The method includes receiving, from an intent owner, a second message, the second message comprising a discovery request for one or more intent handlers. The method includes, in response to the discovery request, obtaining, from the database, a list of one or more intent handlers and basic intent handler profiles corresponding to each of the one or more intent handlers. The method includes generating a third message, the third message comprising the list of one or more intent handlers and basic intent handler profiles corresponding to each of the one or more intent handlers. The method includes transmitting the third message towards the intent owner.

In some embodiments, the method further includes generating a fourth message, the fourth message comprising an identifier of the intent owner; transmitting the fourth message towards each intent handler in the list of one or more intent handlers; and receiving, from each of the one or more intent handlers, a fifth message, the fifth message comprising advanced information to complement the basic intent manager profile of each of the one or more intent handlers, wherein the advanced information comprises a second set of information different than the first set of information and the third message further comprises the advanced information.

In some embodiments, the advanced information comprises one or more of: a notation format, an interface procedure, a supported model, or a partially supported model. In some embodiments, the advanced information enables support of one or more intents relating to at least one of: optimal performance, cost, or delivery of a proprietary feature in a communications network. In some embodiments, the basic intent manager profile comprises: an intent manager address, an intent management scope, and an intent life cycle role. In some embodiments, the identifier of the intent owner comprises one or more of a uniform resource identifier (URI) or an internet protocol (IP) address of the intent owner. In some embodiments, the basic intent handler profile comprises an intent common model and the advanced information comprises one or more extensions to the intent common model.

According to another aspect, a method performed by an intent owner in a communications network is provided. The method includes generating a first message, the first message comprising a discovery request for an intent handler. The method includes transmitting the first message towards an intent manager registry. The method includes receiving, from the intent manager registry, a second message comprising a list of one or more intent handlers and basic intent handler profiles corresponding to each of the one or more intent handlers, wherein each basic intent handler profile comprises a first set of information relating to one or more capabilities of an intent handler. The method includes selecting an intent handler based on the list of one or more basic intent handler profiles. The method includes generating a third message, the third message comprising an identifier of the intent owner. The method includes transmitting the third message towards the selected intent handler. The method includes receiving a fourth message comprising advanced information to complement the basic intent manager profile of the selected intent handler.

In some embodiments, the fourth message is received from the selected intent handler.

In some embodiments, the basic intent manager profile comprises: an intent manager address, an intent management scope, and an intent life cycle role. In some embodiments, the advanced information comprises one or more of: a notation format, an interface procedure, a supported model, or a partially supported model. In some embodiments, the identifier of the intent owner comprises one or more of a uniform resource identifier (URI) or an internet protocol (IP) address of the intent owner. In some embodiments, the basic intent handler profile comprises an intent common model and the advanced information comprises one or more extensions to the intent common model. In some embodiments, the advanced information enables support of one or more intents relating to at least one of: optimal performance, cost, or delivery of a proprietary feature in a communications network.

In some embodiments, in response to a determination that the intent owner belongs to a same network operator of the communications network as the selected intent handler, the advanced information comprises information relating to capabilities of the selected intent handler for a proprietary feature in the network. In some embodiments, in response to a determination that the intent owner does not belong to a same network operator of the communications network as the selected intent handler, the advanced information comprises information relating to capabilities of the selected intent handler for a non-proprietary feature in the network.

In some embodiments, the discovery request comprises an intent management scope. In some embodiments, the intent management scope comprises one or more of: contract negotiation scope, order management scope, regulatory policies scope, operator policies scope, service orchestration and assurance scope, core network intent management scope, transport management scope, slice management scope, or network function management scope.

In another aspect there is provided a network node adapted to perform the methods described above. In another aspect there is provided a computer program comprising instructions which when executed by processing circuity of a network node causes the network node to perform the methods described above. In another aspect there is provided a carrier containing the computer program of claim 31, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates intent manager registration and discovery.

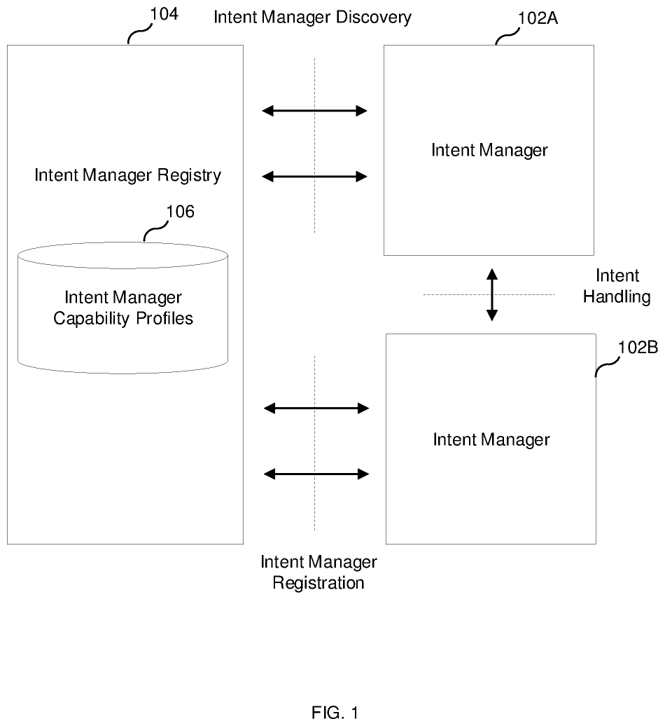

FIG. 2 illustrates classes and properties for expressing intent manager profiles.

FIG. 3 illustrates three phases for intent-based management, according to some embodiments.

FIG. 4 illustrates two phases for intent-based management, according to some embodiments.

FIG. 5 illustrates a flow diagram, according to some embodiments.

FIG. 6 illustrates a method, according to some embodiments.

FIG. 7 illustrates a method, according to some embodiments.

FIG. 8 illustrates a method, according to some embodiments.

FIG. 9 illustrates a block diagram of a network node, according to some embodiments.

### DETAILED DESCRIPTION

Aspects of the present disclosure relate to dynamic creation of different intent manager profiles that are used to expose different intent models and different interface procedures and allow intent managers to choose the right level of capabilities exposure. The different intent manager profiles may be created based on a unique identifier of the intent owner requesting such information, and further based on any type of business decisions (i.e., do not expose detailed intent models to competitors, or to specific industries)

The request for the intent manager profiles can come directly from the intent owner after an initial request/response flow between the intent owner and the intent manager registry. Alternatively, the request for the intent manager profiles can be redirected by the intent manager registry from the intent owner towards the intent handler.

A few concepts related to this disclosure are provided below. These concepts are based on the work done in TM Forum's Autonomous Networks, but are also generic enough to be applied in any intent-based management system.

Intent modeling—the intent models are based on ontologies that use the Resource Description Framework (RDF)/Resource Description Framework Schema (RDFS) suite. The ontologies are formed by a mandatory intent common model and optional intent extension models.

Intent models federation—the intent extension models can be created by different organizations and can be federated to create intents that express requirements coming from different management domains.

Intent manager—intents are knowledge objects that need to be lifecycle managed; the intent managers are the logical entity involved in the intent life cycle management. Intent managers can play the role of owners (originator of the requirements) and/or intent handlers (receiving entity that must fulfil the requirements).

Intent owner—intent manager that originates the intents, i.e., the requirements, goals and constraints.

Intent handler—intent manager that fulfils the intents, i.e., receives the intents from an intent owner and fulfils the requirements, goals and constraints.

Intent management function—same as intent manager.

Intent manager registry—the intent managers exchange intents (as formal definition of the requirements) and intent reports (as formal feedback on the intent fulfilment). The intent managers need to publish and query their capabilities to allow machine-driven automation. The registration and discovery of intent manager capabilities is achieved with the intent manager registries.

Intent manager profile—the list of capabilities of an intent manager (e.g., management scope, supported models, interfaces, notations, etc.).

Intents are used to support autonomous networks since it is a way of formally defining the requirements, goals and constraints of the different parties involved in management. Moreover, since intents are formally expressed, they can be generated and processed by machines and enable fully automated systems. The types of requirements, goals and constraints that are used in an intent-driven system can also be dynamically adjusted, which allows machines to have different types of interactions automatically adjusted according to some business-related policies. In this sense, aspects of the present disclosure enable the dynamic exposure of capabilities of intent manager to allow such flexibility.

Some advantages of the proposed solution include, for example:

Dynamic exposure of intent-related capabilities—which types of intents an intent manager is willing to receive from other intent manager can be defined based on the intent extension models that are supported in the intent manager profile. The supported models together with the supported interface procedures can be changed according to any business and/or technical goal/rule. This also allows an intent manager to hide its internal complexity from other competitors, since exposing the intent extension models may give clues about the advance handling capabilities of an intent manager.

Different business relationships between intent managers—the right exposure of intent-related capabilities may allow the establishment of different business relationships between intent managers and the decision about which relationship to create can be taken dynamically (i.e., can change over time) by the intent managers. One company decide to only accept certain types of intents from intent managers from a competitor; two operators may decide to support specialized intent models to be exchanged for optimized network management, or on the other hand, may only expose standardized intent models and hide some of the internal management details that are part of non-standardized intent models; other commercial relationships can be facilitated with different intent manager profiles being created.

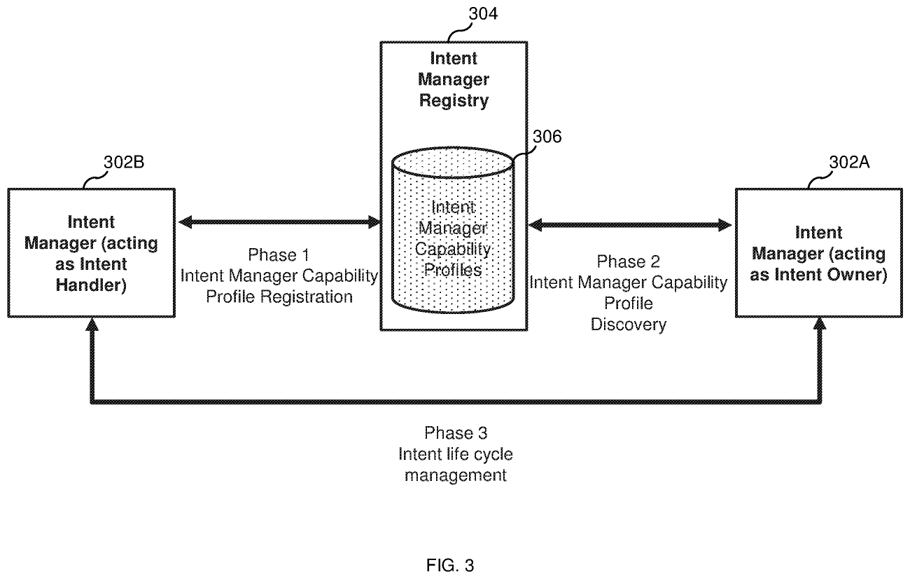

FIG. 3 shows three phases for intent-based management, according to some embodiments. FIG. 3 illustrates an intent manager acting as an intent owner (302A), an intent manager acting as an intent handler (302B), and an intent manager registry (304) with intent manager capability profiles (306).

Phase 1, i.e., intent manager capability profile registration, involves the registration of the intent manager profiles of all intent managers that are involved in any intent-based management, so that their capabilities can be later discovered by interested intent managers. This phase is required since in intent-based management, different intent managers exchange intents, and these need to be created based on the supported intent extension models and communicated through an interface using the supported interface procedures. Therefore, the intent manager profile is an artifact that needs to be knows by any intent owner that wants to send an intent to any intent handler. All intent managers (302B) must register its own intent manager profiles (306) in a common (set of) intent manager registry(ies) (304).

Phase 2, i.e., intent manager capability profile discovery, involves the discovery of the intent handler's (302B) profile before an intent is created and sent by an intent owner (302A). In principle, if the whole intent manager profile is stored in the intent manager registry (304), this phase is solved with a simple query that may involve filters or a specific intent manager ID. Alternatively, if the intent manager profile is dynamically created depending on the context (e.g., who is the intent owner requesting such information), further steps may be necessary as described herein.

Phase 3, i.e., intent life cycle management, involves the different possible operations for the management of intents as information objects. Examples of life cycle management operations are creation of the intent, modification, deletion, query, or optional operations for negotiation of the best intent to be used. Phases 1 and 2 are necessary prior to phase 3, since both sides of intent exchange, i.e., intent owner (302A) and intent handler (302B), need to know each other's capabilities.

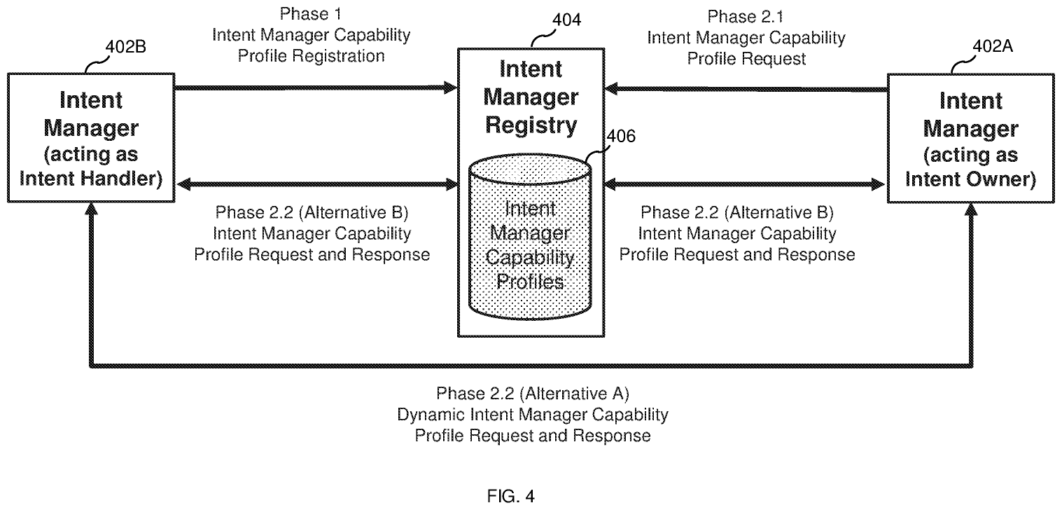

FIG. 4 illustrates detailed steps of phase 1 and phase 2, according to some embodiments. FIG. 4 similarly illustrates an intent manager acting as an intent owner (402A), an intent manager acting as an intent handler (402B), and an intent manager registry (404) with intent manager capability profiles (406). In phase 1, the intent handler (402B) registers its manager profile in the intent manager registry (404), but the registered manager profile does not include the supported intent extension models and the interface procedures. In some embodiments, the registered manager profile is referred to herein as a basic intent handler profile. This means that phase 1 registers the intent handler with partial information, and further requests should be forwarded to the intent handler to complete its capabilities profile. In some embodiments, the information used to complete the basic intent handler profile is referred to herein as advanced information.

In Phase 2.1 (FIG. 4), the intent owner (402A) requests the intent manager profile for a specific intent manager ID or with specific filters, e.g., all intent managers with management scope X. Since the intent manager registry (404) does not contain the full intent manager profiles, further exchange is required following an intent manager profile request.

Following Phase 2.1, the intent owner (402A) has to discover additional information that is not stored in the intent manager registry (404) and can only be created dynamically by the intent handler (402B) based on the intent owner's ID.

In some embodiments, one alternative for the next interactions is where the intent owner (402A) requests the additional information directly from the intent handler (402B), as shown in Phase 2.2 (Alternative A) in FIG. 4. In this case, the additional request coming from the intent owner allows the intent handler to select the most appropriate information to complete the intent manager profile before sending it to the intent owner. This is possible because, with a direct request, the intent handler knows the intent owner's ID and can provide the most suitable intent manager profile. In some embodiments, the additional information/advanced information that is sent to the intent owner include the supported intent extension models and the supported interface procedures.

In other embodiments, a second alternative is where the intent manager profile request is forwarded to the intent handler (402B) together with the ID of the intent owner (402A) that has issued the request, so that the intent handler can complete the intent manager profile information and send back this information to the intent manager registry (404). This is illustrated in Phase 2.1 (Alternative B) in FIG. 4. In this alternative, the intent manager registry (404) works as a proxy and the generation of the intent manager profile is totally transparent to the intent owner issuing the request (i.e., the intent owner does not know that the information in the intent manager profile was dynamically created based on its ID).

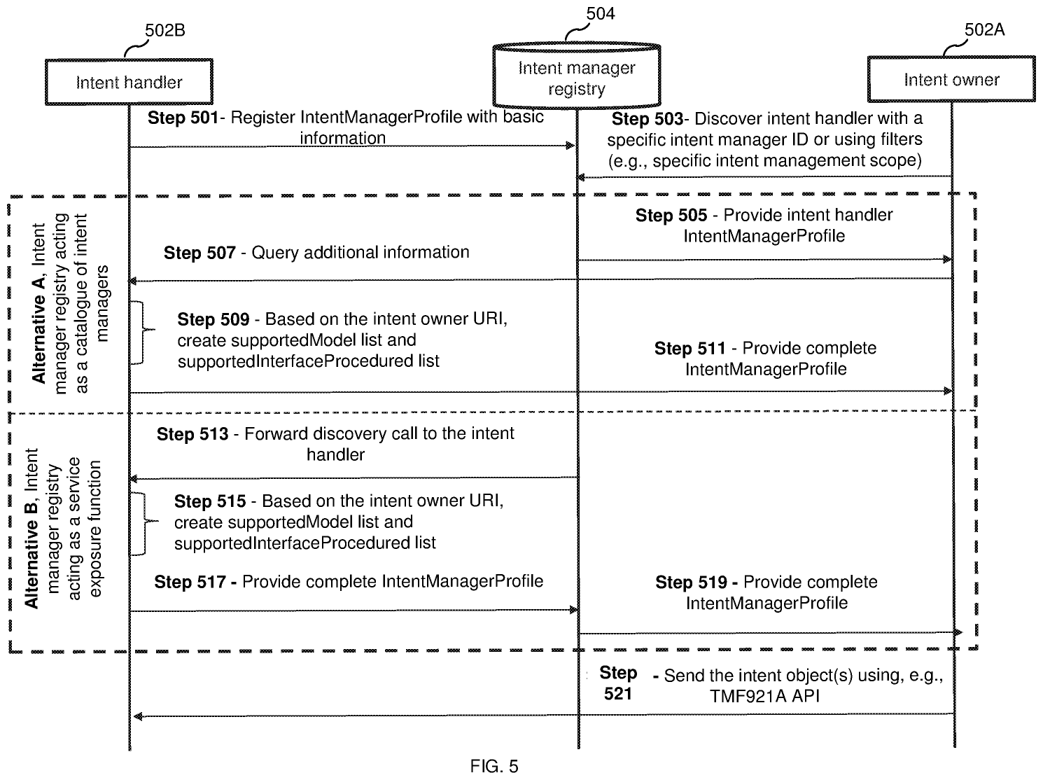

FIG. 5 is a flow diagram, according to some embodiments. FIG. 5 illustrates a message flow among an intent owner (502A), and intent manager registry (504), and an intent handler (502B).

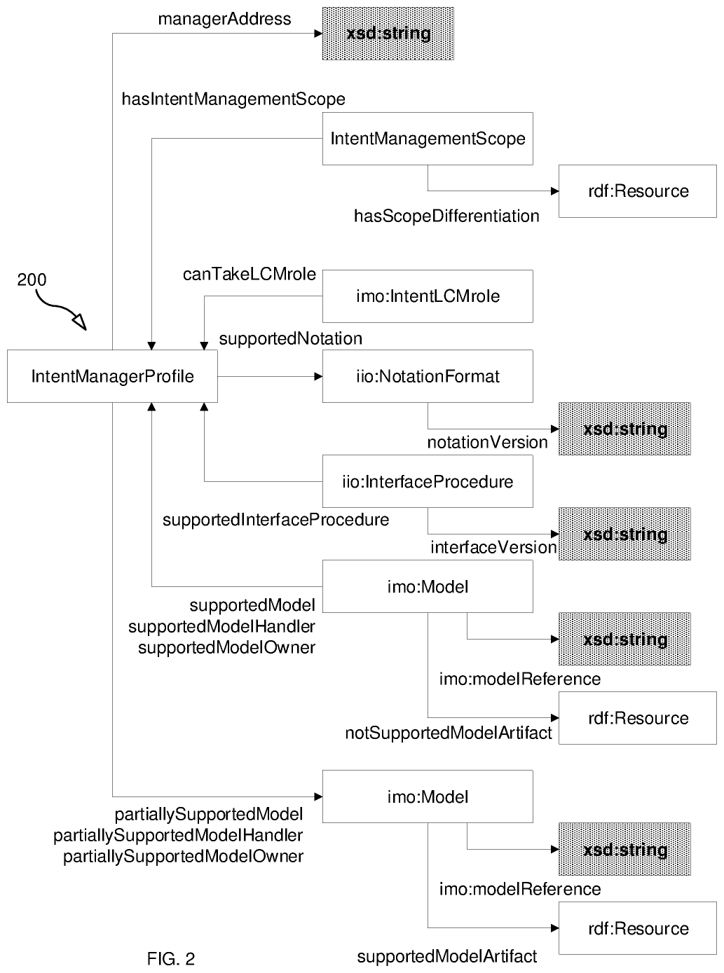

Step 501—All intent managers need to be registered in an intent manager registry. The intent manager registry is a logical entity that can be composed of one or multiple databases and can be centralized or distributed in the network. The information that composes an intent manager profile can be standardized or proprietary. One relevant standard is IG1253D, and with the intent manager profile shown in FIG. 2. According to some embodiments, step 501 involves only the registration of the intent handler with basic information (the “basic intent handler profile”), which can be used for further inquiries about more advanced information.

In some embodiments, the minimum information needed for intent handler registration with the basic intent handler profile, considering IG1253D [5], includes a Manager Address, Intent Management Scope, and Intent Life Cycle Roles. Advanced information that can be requested after the intent handler is discovered, considering IG1253D [5], may include Notation Formats, Interface Procedures, Supported Models, Partially Supported Models. In some embodiments, the most relevant advanced information are Supported Models and Interface Procedures.
Step 503—An intent owner (502A) that has an intent has to find the most appropriate intent handler (502B) to fulfil that given intent. The discovery of the best intent handler can be done by querying the intent manager registry (504) using the intent handler ID, if already known, or any other applicable filters. One example of common filtering criteria is the intent management scope. Management scope is the delineation of responsibility for operational tasks within a system domain or sub-system. By associating a defined scope, the intent manager claims that it is the responsible entity for all intent targeting this scope.

Examples of intent management scopes may include, as exemplified in IG1253D [5]:
At the business layer—contract negotiation scope, order management scope, regulatory policies scope, operator policies scope.
At the service layer—service orchestration and assurance scope.
At the resource operation layer—core network intent management scope, transport management scope, slice management scope, network function management scope.

After an intent manager profile discovery, there are two possibilities for the reply that is sent by the intent manager registry. Alternative A is to send the intent manager profile with basic information directly to the intent owner and let it request the advanced information directly to the intent handler. Alternative B is to first request the advanced information to the intent handler, consolidate with the basic information, and then send the complete intent manager profile to the intent owner. In some embodiments, steps 507-511 are for Alternative A, while steps 513-519 are for Alternative B.
Step 505—After the intent manage registry receives a discovery request, it responds with a list of Intent Manager Profiles that match the request criteria. The intent manager profiles contain only basic information, which was registered by the intent manager in Step 501.
Step 507—After receiving the list of intent manager profiles, the intent owner can select the best intent handler and, then, request advanced information, such as Notation Formats, Interface Procedures, Supported Models, and/or Partially Supported Models. The request can be done directly with the intent handler because the intent owner knows at least the Intent Address, which is a basic information that was provided by the intent manager registry.
Step 509—Based on the intent owner identification, which can be derived from its URI (Uniform Resource Identifier) or other means, such as IP (Internet Protocol) address, the intent handler can decide on the most appropriate advanced information to be sent and used to complement the intent manager profile together with the basic information that was already retrieved from the intent manager registry.
Step 511—The intent handler provides the complete intent manager profiles to the intent owner. The complete intent manager profiles contain the advance information that was dynamically selected according to the requestor (i.e., the intent owner).
Step 513—The request for the intent manager profile is forwarded to the different intent managers that are applicable, i.e., to all intent managers that match the request criteria.
Step 515—Based on the intent owner identification, which can be derived from its URI (Uniform Resource Identifier) or other means, such as IP address, the intent handler can decide on the most appropriate advanced information to be sent and used to complement the intent manager profile together with the basic information that was already retrieved from the intent manager registry.
Step 517—The intent handler provides the complete intent manager profiles to the intent manager registry that are responsible to forward it the intent owner. The complete intent manager profiles contain the advance information that was dynamically selected according to the requestor (i.e., the intent owner).
Step 519—The intent manager registry finally provides the complete intent manager profiles to the intent owner. The complete intent manager profiles contain the advance information that was dynamically selected according to the requestor (i.e., the intent owner).
Step 521—Based on the complete intent manager profile that was sent either with Alternative A or Alternative B solutions, the intent owner now is capable of using the most appropriate intent extension models to create the intent, and to use the right interface procedures to perform the life cycle management of the intent, i.e., create, modify, negotiate, etc.

According to some aspects, the techniques disclosed herein may be implemented as a (part of) a virtual network function or part of existing network functions; therefore, it could run in a cloud environment.

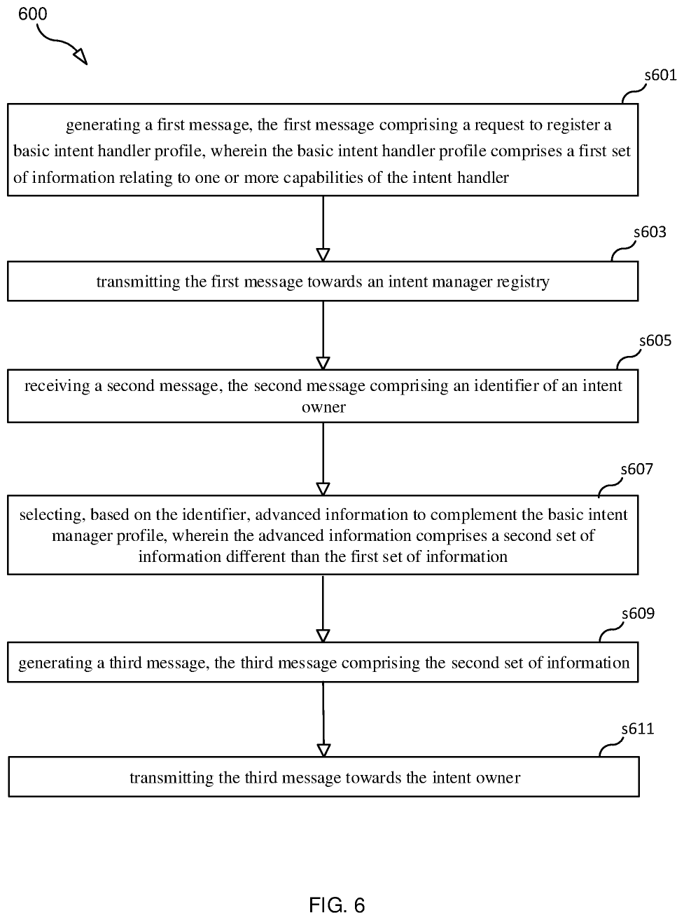

FIG. 6 illustrates a method, according to some embodiments. In some embodiments, method 600 is performed by an intent handler for managing intents in a communications network.
Step s601 of the method includes generating a first message, the first message comprising a request to register a basic intent handler profile, wherein the basic intent handler profile comprises a first set of information relating to one or more capabilities of the intent handler.
Step s603 of the method includes transmitting the first message towards an intent manager registry.
Step s605 of the method includes receiving a second message, the second message comprising an identifier of an intent owner.
Step s607 of the method includes selecting, based on the identifier, advanced information to complement the basic intent manager profile, wherein the advanced information comprises a second set of information different than the first set of information.
Step s609 of the method includes generating a third message, the third message comprising the second set of information.
Step s611 of the method includes transmitting the third message towards the intent owner.

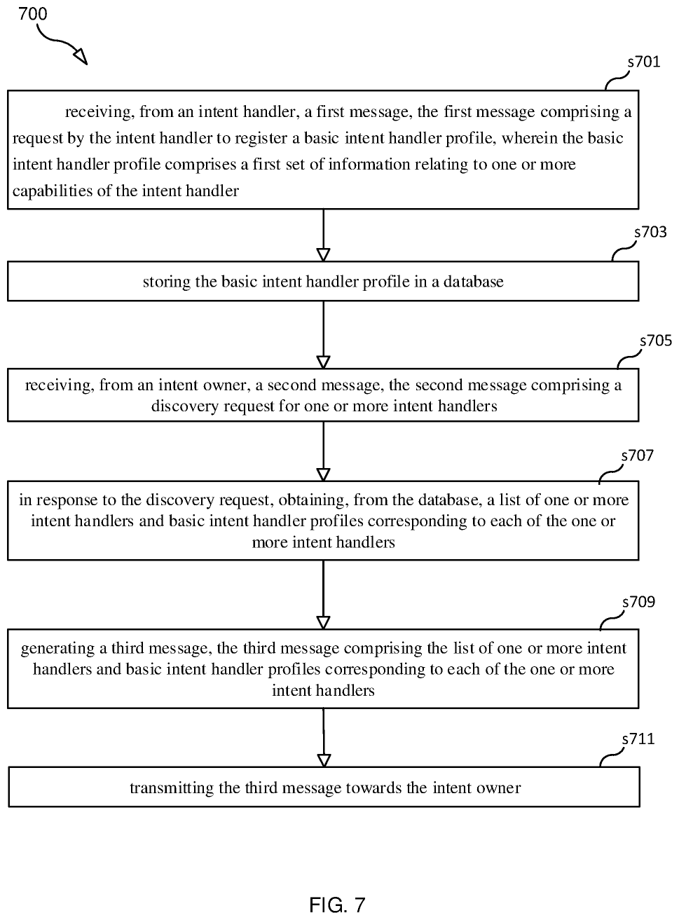

FIG. 7 illustrates a method, according to some embodiments. In some embodiments, method 700 is performed by an intent manager registry in a communications network.
Step s701 includes receiving, from an intent handler, a first message, the first message comprising a request by the intent handler to register a basic intent handler profile, wherein the basic intent handler profile comprises a first set of information relating to one or more capabilities of the intent handler.
Step s703 includes storing the basic intent handler profile in a database.
Step s705 includes receiving, from an intent owner, a second message, the second message comprising a discovery request for one or more intent handlers.
Step s707 includes, in response to the discovery request, obtaining, from the database, a list of one or more intent handlers and basic intent handler profiles corresponding to each of the one or more intent handlers.
Step s709 includes generating a third message, the third message comprising the list of one or more intent handlers and basic intent handler profiles corresponding to each of the one or more intent handlers.
Step s711 includes transmitting the third message towards the intent owner.

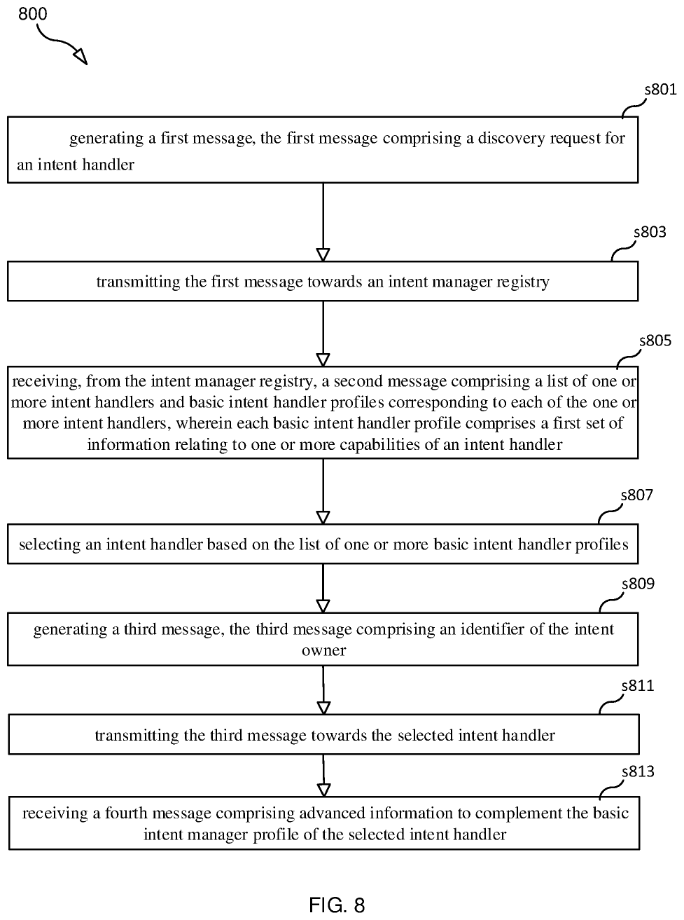

FIG. 8 illustrates a method, according to some embodiments. In some embodiments, method 800 is performed by an intent owner in a communications network.
Step s801 includes generating a first message, the first message comprising a discovery request for an intent handler.
Step s803 includes transmitting the first message towards an intent manager registry.
Step s805 includes receiving, from the intent manager registry, a second message comprising a list of one or more intent handlers and basic intent handler profiles corresponding to each of the one or more intent handlers, wherein each basic intent handler profile comprises a first set of information relating to one or more capabilities of an intent handler.
Step s807 includes selecting an intent handler based on the list of one or more basic intent handler profiles.
Step s809 includes generating a third message, the third message comprising an identifier of the intent owner.
Step s811 includes transmitting the third message towards the selected intent handler.
Step s813 includes receiving a fourth message comprising advanced information to complement the basic intent manager profile of the selected intent handler.

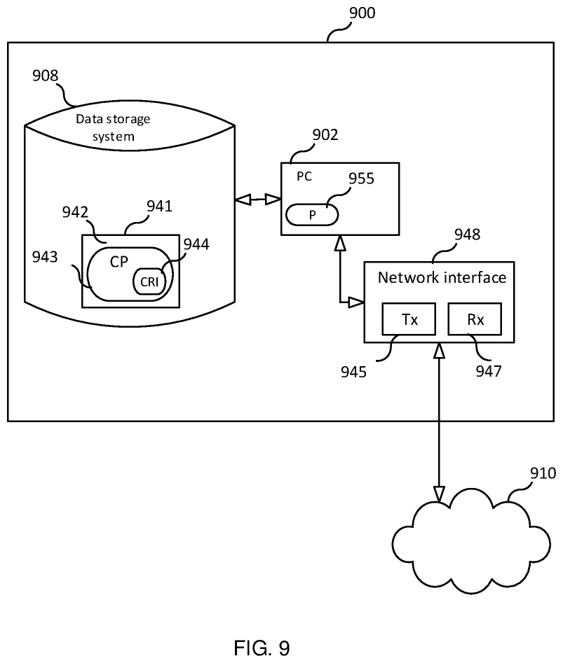

FIG. 9 is a block diagram of a network node 900 according to some embodiments. In some embodiments, network node 900 may comprise one or more of the components of an intent handler, intent owner, and/or intent manager registry as described herein. As shown in FIG. 9, the node may comprise: processing circuitry (PC) 902, which may include one or more processors (P) 955 (e.g., one or more general purpose microprocessors and/or one or more other processors, such as an application specific integrated circuit (ASIC), field-programmable gate arrays (FPGAs), and the like); communication circuitry 948, comprising a transmitter (Tx) 945 and a receiver (Rx) 947 for enabling the node to transmit data and receive data (e.g., wirelessly transmit/receive data) over network 910; and a local storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 includes a computer readable medium (CRM) 942 storing a computer program (CP) 943 comprising computer readable instructions (CRI) 944. CRM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes the node to perform steps described herein (e.g., steps described herein with reference to the flow charts). In other embodiments, the node may be configured to perform steps described herein without the need for code. That is, for example, PC 902 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] IG1253—TM Forum—“Intent in Autonomous Networks”
[2] TR290—TM Forum—“Intent Common Model”
[3] TR291-TM Forum “Intent Extension Models”
[4] IG1253C—TM Forum—“Intent Life Cycle Management and Interface”
[5] IG1253D—TM Forum—“Intent Manager Capability Profiles”
[6] TMF921A—TM Forum—“Intent Management API Profile”

### ABBREVIATIONS

RDF Resource Description Framework
RDFS RDF Schema
SMO Service Management and Orchestration
ZSM Zero-touch Network and Service Management

1. A method performed by an intent handler for managing intents in a communications network, the method comprising:
generating a first message, the first message comprising a request to register a basic intent handler profile, wherein the basic intent handler profile comprises a first set of information relating to one or more capabilities of the intent handler;
transmitting the first message towards an intent manager registry;
receiving a second message, the second message comprising an identifier of an intent owner;
selecting, based on the identifier, advanced information to complement the basic intent manager profile, wherein the advanced information comprises a second set of information different than the first set of information;
generating a third message, the third message comprising the second set of information; and
transmitting the third message towards the intent owner.

2. The method of claim 1, wherein the second message is received from the intent owner.

3. The method of claim 1, wherein the second message is received from the intent manager registry.

4. The method of claim 3, wherein the third message is transmitted towards the intent owner via the intent manager registry.

5. The method of claim 1, wherein the basic intent manager profile comprises: an intent manager address, an intent management scope, and an intent life cycle role.

6. The method of claim 1, wherein the advanced information comprises one or more of: a notation format, an interface procedure, a supported model, or a partially supported model.

7. The method of claim 1, wherein the identifier comprises one or more of a uniform resource identifier (URI) or an internet protocol (IP) address of the intent owner.

8. The method of claim 1, wherein the basic intent handler profile comprises an intent common model and the advanced information comprises one or more extensions to the intent common model.

9. The method of claim 1, wherein the advanced information enables support of one or more intents relating to at least one of: optimal performance, cost, or delivery of a proprietary feature in a communications network.

10. The method of claim 1, wherein the selecting further comprises determining, based on the identifier, that the intent owner belongs to a same network operator of a communications network as the intent handler, and wherein the advanced information comprises information relating to capabilities of the intent handler for a proprietary feature in the network.

11. The method of claim 1, wherein the selecting further comprises determining, based on the identifier, that the intent owner belongs to a different network operator of a communications network as the intent handler, and wherein the advanced information comprises information relating to capabilities of the intent handler for a non-proprietary feature in the network.

12. A method performed by an intent manager registry in a communications network, the method comprising:
receiving, from an intent handler, a first message, the first message comprising a request by the intent handler to register a basic intent handler profile, wherein the basic intent handler profile comprises a first set of information relating to one or more capabilities of the intent handler;
storing the basic intent handler profile in a database;
receiving, from an intent owner, a second message, the second message comprising a discovery request for one or more intent handlers;
in response to the discovery request, obtaining, from the database, a list of one or more intent handlers and basic intent handler profiles corresponding to each of the one or more intent handlers;
generating a third message, the third message comprising the list of one or more intent handlers and basic intent handler profiles corresponding to each of the one or more intent handlers; and
transmitting the third message towards the intent owner.

13. A method performed by an intent owner in a communications network, the method comprising:
generating a first message, the first message comprising a discovery request for an intent handler;
transmitting the first message towards an intent manager registry;
receiving, from the intent manager registry, a second message comprising a list of one or more intent handlers and basic intent handler profiles corresponding to each of the one or more intent handlers, wherein each basic intent handler profile comprises a first set of information relating to one or more capabilities of an intent handler;
selecting an intent handler based on the list of one or more basic intent handler profiles;
generating a third message, the third message comprising an identifier of the intent owner;
transmitting the third message towards the selected intent handler; and
receiving a fourth message comprising advanced information to complement the basic intent manager profile of the selected intent handler.

14. A network node adapted to perform the method of claim 1.

15. A computer program comprising instructions which when executed by processing circuity of a network node causes the network node to perform the method of claim 1.

16. (canceled)
